(19) United States
(12) Patent Application Publication
(10) Pub. No.: US 2016/0195319 A1
(43) Pub. Date: Jul. 7, 2016

(54) REFRIGERATING CIRCUIT FOR USE IN A MOTOR VEHICLE

(71) Applicant: Dr. Ing. h.c.F. Porsche Aktiengesellschaft, Stuttgart (DE)

(72) Inventors: Robert Fleischhacker, Magstadt (DE); Thomas Tscheppe, Oetigheim (DE); Bastian Freese, Ostfildern (DE)

(21) Appl. No.: 15/007,826

(22) Filed: Jan. 27, 2016

Related U.S. Application Data
(62) Division of application No. 13/603,464, filed on Sep. 5, 2012, now abandoned.

(30) Foreign Application Priority Data
Sep. 5, 2011 (DE) 10 2011 053 256.0

(51) Int. Cl. F25B 43/00; B60H 1/32; F25B 41/00; F25B 41/06; F25B 40/06

(52) U.S. Cl. CPC F25B 43/00; F25B 41/062; F25B 40/06; F25B 41/00; B60H 1/3227; F25B 2600/2513; F25B 2341/0683

(57) ABSTRACT

A refrigerating circuit for use in a motor vehicle has a refrigerant compressor (8) connected on the output side to a pressure line (4) and on the input side to a suction line (6). The refrigerating circuit has at least one condenser (10), at least one regulated expansion valve (14), at least one evaporator (16) and at least one inner heat exchanger (12). The regulated expansion valve (14) has a temperature t_{E} in a detection zone (20) of the suction line (6) as a controlled variable. The detection zone (20) for the regulated expansion valve (14) is arranged at the output of the inner heat exchanger (12).

### CROSS REFERENCE TO RELATED APPLICATION

The present application is a divisional application of U.S. patent application Ser. No. 13/603,464, filed Sep. 5, 2012, the contents of which are hereby incorporated by reference in their entirety. Application No. 13/603,464 claims priority under 35 USC 119 to German Patent Appl. No. 10 2011 053 256.0 filed on Sep. 5, 2011, the entire disclosure of which is incorporated herein by reference.

### BACKGROUND OF THE INVENTION

1. Field of the Invention

The invention relates to a refrigerating circuit for use in a motor vehicle.

2. Description of the Related Art

Refrigerating circuits for motor vehicles are well known. In the simplest type of structure of a refrigerating circuit of this kind, a pressure line runs from the output of the compressor, through the condenser, to the input of the expansion valve. The pressure is lowered in the expansion valve, and therefore the suction line is connected to the output of the expansion valve, leading through the evaporator and ending at the input of the compressor. The compressor changes the state of the refrigerant in respect of pressure and temperature. In this case, the temperature at the compressor outlet is higher than the condensing temperature in the condenser since the vaporous refrigerant is highly superheated. The refrigerant is still in a highly superheated state at the condenser inlet. The condenser releases heat to the environment, and therefore the refrigerant is in a liquid state at the outlet of the condenser. The refrigerant has a particular condensing temperature and a particular condensing pressure, that are referred to as the saturated temperature and the saturated pressure. The liquid is supercooled at the condenser outlet, and hence achieves a temperature lower than the saturation temperature. There is a further change in the state of the refrigerant in the expansion valve. More particularly, the pressure reduction performed in the expansion valve causes the refrigerant to begin to boil. As a result, there is a mixture of refrigerant in the liquid and the vapor state at the compressor inlet. The refrigerant absorbs heat in the evaporator and therefore is in the vapor state at the evaporator outlet and in this way is sucked in by the compressor in the suction line. The refrigerant at the evaporator output must be in a superheated gaseous state to avoid damage to the compressor. A regulated expansion valve may be used to ensure that the refrigerant is in the superheated state at the output of the evaporator. In this case, the expansion valve has the temperature t_{E} at the output of the evaporator as the controlled variable. If the refrigerant is then in a highly superheated state, i.e. at a high temperature t_{E}, too little refrigerant is injected into the evaporator, and the mass flow rate of the refrigerant may increase. Conversely, the valve opening becomes smaller as the detector temperature falls in relation to the temperature in the superheated state at the evaporator output. An inner heat exchanger may be used in the pressure and the suction line to improve efficiency of a refrigerating circuit of this kind. The inner heat exchanger passes the cooled refrigerant under high pressure to the expansion valve, and the superheated expanded refrigerant is passed to the compressor. As a result, the refrigerant to be condensed is supercooled further so that the proportion of liquid in the refrigerant after expansion rises and hence more liquid refrigerant is available for evaporation. The inner heat exchanger thereby increases the refrigerating capacity and also the efficiency of the refrigerating circuit.

Improved efficiency can lead to a reduction in the power consumption of the compressor, thereby achieving reductions in fuel consumption and emissions. The reduced power requirement also may be enable use of a smaller compressor.

It is therefore the object of the invention to provide a more efficient refrigerating circuit for use in a motor vehicle.

### SUMMARY OF THE INVENTION

The invention relates to a refrigerating circuit with a regulated expansion valve that has a detection zone arranged at the suction-side output of the inner heat exchanger. This arrangement functions as a control means for ensuring that only gaseous refrigerant is present at the compressor input, while enabling the refrigerant to still be in the mixed/vapor state at the evaporator output. Only after passing through the inner heat exchanger is the refrigerant in the gaseous state. In this way, the refrigerant can be supercooled to a greater extent, thereby making it possible to improve heat release in the evaporator, this in turn having a positive effect on efficiency. Moreover, the refrigerating circuit of the invention ensures that the cooling capacity of the refrigerant is distributed uniformly over the entire evaporator since the refrigerant is in the wet vapor phase in the entire evaporator zone.

The regulated expansion valve preferably is a thermostatic expansion valve connected by a control line that is part of the suction line to the output of the inner heat exchanger.

The regulated expansion valve preferably is a thermostatic expansion valve with a detector arrangement with a detector in the detection zone.

The invention is explained in greater detail below with reference to the drawing.

### BRIEF DESCRIPTION OF THE DRAWINGS

FIG. 1 shows a schematic refrigerant circuit according to the invention.

FIG. 2 shows a simplified pressure-enthalpy diagram of a refrigerating circuit in accordance with FIG. 1.

### DETAILED DESCRIPTION OF THE PREFERRED EMBODIMENTS

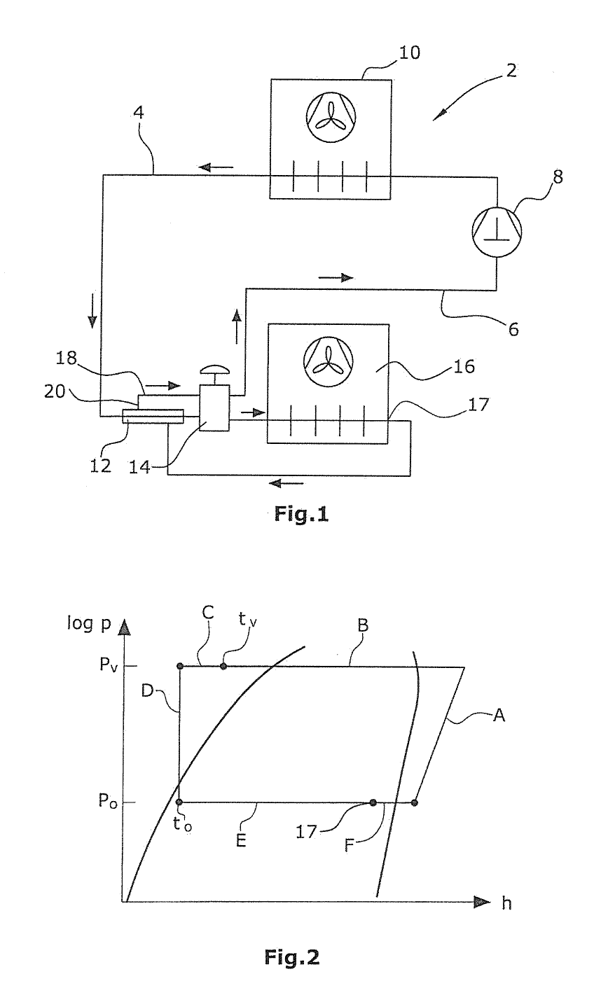

The refrigerating circuit of FIG. 1 has a pressure line 4 and a suction line 6. The pressure line 4 begins at the output of a compressor 8. The compressor 8 compresses the refrigerant to a condensing pressure P_{V}, which is indicated by a change of state A in FIG. 2. The refrigerant is passed at the condensing pressure P_{V} to a condenser 10, in which the refrigerant releases heat so that the refrigerant is liquid at the output of the condenser 10 and has a condensing temperature t_{V}. This change of state is denoted by B in FIG. 2.

The refrigerant is passed from the condenser 10 to an inner heat exchanger 12, in which the refrigerant in the pressure line 4 releases heat to the refrigerant in the suction line 6, as indicated by the change of state C in the pressure-enthalpy diagram of FIG. 2. The refrigerant is passed from the inner heat exchanger 12 at the pressure P_{V} to the regulated expansion valve 14. The control of the expansion valve 14 is explained in greater detail below after the description of the complete refrigerating circuit.

There is a change in the state of the refrigerant in the expansion valve 14 so that the pressure is reduced to P₀, and the temperature decreases to a temperature t₀. The refrigerant then begins to boil and is then in what is referred to as the wet vapor region indicated by the change of state D in FIG. 2.

The suction line 6 begins at the output of the expansion valve 14 and passes the refrigerant to the evaporator 16 where the refrigerant is evaporated to a greater extent and absorbs heat. In contrast to the prior art, this takes place at a constant temperature t₀ and a constant pressure P₀. The refrigerant is still in the wet vapor region at the output 17 of the evaporator 16 and not, as is customary in the prior art, in the superheated state, in which the temperature would already be elevated. The state of heat absorption in the evaporator is indicated by E in FIG. 2. The refrigerant then passes through the inner heat exchanger 12, absorbing heat from the refrigerant in the pressure line 4 and thus being superheated, as indicated by the change of state F in FIG. 2. The refrigerant then passes via the suction line 6, through the expansion valve 14, to the input of the compressor 8, thereby completing the refrigerating circuit 2.

The part of the suction line 6 that leads from the output of the inner heat exchanger 12 to the expansion valve 14 is a control line 18 for the regulated expansion valve 14. The expansion valve 14, is known per se, and is constructed to open at a temperature t_{E}=t₀+tₓ, with the opening and hence the mass flow rate of the refrigerant increasing as tx rises.

The suction line 6 also could be routed directly from the inner heat exchanger 12 to the compressor 8, with a suitable detector arrangement being provided at the output of the inner heat exchanger 12. The arrangement transmits the temperature t_{E} at the output of the heat exchanger to the regulated expansion valve 14 in a suitable manner.

What is claimed is:

1. A method of controlling a refrigerating circuit for use in a motor vehicle, the refrigerating circuit having a refrigerant compressor with an output side connected to a pressure line and an input side connected to a suction line, at least one condenser in the pressure line downstream of the refrigerant compressor, at least one regulated expansion valve, at least one evaporator, and at least one inner heat exchanger, the regulated expansion valve having a temperature t_{E} in a detection zone of the suction line as a controlled variable, the detection zone for the regulated expansion valve being arranged at an output of the inner heat exchanger, wherein the method includes:
adjusting an opening of the regulated expansion valve for controlling a flow of refrigerant through the inner heat exchanger and thereby maintaining the refrigerant flowing through the evaporator in a wet vapor phase and at a constant temperature t_{E}; and
directing only a gaseous refrigerant through the suction line and to the refrigerant compressor.

2. The method of claim 1, wherein the regulated expansion valve is a thermostatic expansion valve connected to one of the outlets of the inner heat exchanger by a control line that is part of the suction line.

3. The method of claim 1, wherein the regulated expansion valve is a thermostatic expansion valve with a detector in the detection zone.

4. The method of claim 1 further comprising maintaining the refrigerant flowing through the evaporator in a wet vapor phase at a constant pressure P₀.

5. The method of claim 1 further comprising decreasing the temperature and pressure of the refrigerant in the temperature-regulated expansion valve sufficiently to achieve the wet vapor phase.

6. The method of claim 1 further comprising causing the refrigerant in the wet vapor phase flowing from the evaporator to flow through the inner heat exchanger and in proximity to the refrigerant in the pressure line and thereby superheating the refrigerant in the inner heat exchanger with heat absorbed from the refrigerant in the pressure line.

7. A method of controlling a refrigerant in a motor vehicle, comprising:
causing a refrigerant in a suction line to flow through a refrigerant compressor and into a pressure line;
causing the refrigerant in the pressure line from the refrigerant compressor to flow through a condenser;
causing the refrigerant in the pressure line from the condenser to flow through a first passage in an inner heat exchanger;
causing the refrigerant to flow from the first passage through the inner heat exchanger to a regulated expansion valve;
operating the regulated expansion valve to cause the refrigerant to flow from the regulated expansion valve through an evaporator in a wet vapor phase at a substantially constant temperature and a substantially constant pressure;
causing the refrigerant in the wet vapor phase to flow from the evaporator to a second passage through the inner heat exchanger;
using heat of the refrigerant in the first passage through the inner heat exchanger to superheat the refrigerant flowing through the second passage; and
causing the refrigerant to flow from the second passage in the inner heat exchanger through the suction line and to the compressor in a gaseous phase.

8. The method of claim 7, wherein the step of causing the refrigerant to flow from the second passage in the inner heat exchanger through the suction line and to the compressor in a gaseous phase further comprises causing the refrigerant to flow through the regulated expansion valve between the second passage through the inner heat exchanger and the compressor.

9. The method of claim 8, wherein the regulated expansion valve is a thermostatic expansion valve with a detector in a detection zone between the inner heat exchanger and the thermostatic expansion valve.
